(19) United States
(12) Patent Application Publication
(10) Pub. No.: US 2025/0333112 A1
(43) Pub. Date: Oct. 30, 2025

(54) ELECTRICALLY POWERED VEHICLE

(71) Applicant: TOYOTA JIDOSHA KABUSHIKI KAISHA, Toyota-shi Aichi-ken (JP)

(72) Inventors: Mitsuaki NEGITA, Chiryu-shi Aichi-ken (JP); Junichi TAKAYANAGI, Nagoya-shi Aichi-ken (JP)

(73) Assignee: TOYOTA JIDOSHA KABUSHIKI KAISHA, Toyota-shi Aichi-ken (JP)

(21) Appl. No.: 19/185,441

(22) Filed: Apr. 22, 2025

(30) Foreign Application Priority Data
Apr. 25, 2024 (JP) 2024-071237

(51) Int. Cl. B62D 21/15; B60K 6/28; B60K 6/40; B60K 13/04

(52) U.S. Cl. CPC B62D 21/157; B60K 6/28; B60K 6/40; B60K 13/04

(57) ABSTRACT

An electrically powered vehicle includes an engine, a driving battery disposed under a floor of a body, and an exhaust pipe connected to the engine and extending in the vehicle longitudinal direction to be disposed toward a right-side outer side of the driving battery in the vehicle width direction. The electrically powered vehicle has a left impact absorbing member disposed toward a left-side outer side of the driving battery in the vehicle width direction.

### CROSS REFERENCE TO RELATED APPLICATION

This application claims priority to Japanese Patent Application No. 2024-071237 filed on Apr. 25, 2024, which is incorporated herein by reference in its entirety including the specification, claims, drawings, and abstract.

### TECHNICAL FIELD

The present disclosure relates to a structure of an electrically powered vehicle having mounted therein an internal combustion engine and a driving battery.

### BACKGROUND

WO 2013/065798 discloses a hybrid electric vehicle including an internal combustion engine, a driving battery pack disposed under the floor of the vehicle body, and an exhaust pipe from the internal combustion engine, wherein the exhaust pipe is disposed toward the outside of the driving battery pack as viewed in the vehicle width direction.

### SUMMARY

In recent years, larger driving batteries are demanded in order to extend the electrically powered driving range of electrically powered vehicles, including hybrid electric vehicles. For this purpose, one approach is to increase the length of a driving battery in the vehicle width direction. However, an increase in length of a driving battery in the vehicle width direction may narrow clearance between a side end of the vehicle and a side portion of the driving battery, resulting in lack of sufficient space to absorb impact energy upon a side collision.

Therefore, the present disclosure is directed toward providing an electrically powered vehicle that enables an increased length of a driving battery in the vehicle width direction while ensuring absorption of impact energy upon a side collision.

According to an aspect of the present disclosure, there is provided an electrically powered vehicle comprising an internal combustion engine; a driving battery disposed under a floor of a body; a pipe connected to the internal combustion engine and extending in a vehicle longitudinal direction to be disposed toward a first-side outer side of the driving battery in a vehicle width direction; and a second-side impact absorbing member disposed toward a second-side outer side of the driving battery in the vehicle width direction.

Upon a side collision of the vehicle on the second side, the second-side impact absorbing member absorbs impact energy, thus eliminating the necessity to provide space for absorbing impact energy in a side portion of the body. This enables an increased length of the driving battery in the vehicle width direction.

The electrically powered vehicle of the present disclosure may further comprise a first-side impact absorbing member disposed toward the first-side outer side of the driving battery in the vehicle width direction, and the length of the first-side impact absorbing member in the vehicle width direction may be shorter than that of the second-side impact absorbing member.

This enables absorption of impact energy upon a side collision on the first side where the pipe is disposed.

In the electrically powered vehicle of the present disclosure, the pipe may extend in the vehicle longitudinal direction in a first-side vehicle side portion of the body, and the driving battery may be disposed toward a second side of the body with a length between a second-side outer end of the driving battery in the vehicle width direction and a second-side outer end of the body in the vehicle width direction being shorter than a length between a first-side outer end of the driving battery in the vehicle width direction and a first-side outer end of the body in the vehicle width direction.

This enables a larger driving battery that extends to the vicinity of the second-side side end of the vehicle.

In the electrically powered vehicle of the present disclosure, the body may include a first-side rocker disposed in the first-side vehicle side portion of the body and extending in the vehicle longitudinal direction, and a second-side rocker disposed in a second-side vehicle side portion of the body and extending in the vehicle longitudinal direction, the second-side impact absorbing member may connect between a lower portion of the second-side rocker and the second-side outer end of the driving battery in the vehicle width direction, and the second-side outer end of the driving battery in the vehicle width direction may extend in the vehicle width direction to reach a vicinity of the second-side rocker.

This enables absorption of impact energy by allowing the second-side impact absorbing member to collapse upon a side collision as a shock load input from the second-side rocker is received by the driving battery having high strength. Therefore, it is unnecessary to provide space for absorbing impact energy in a side portion of the body, and the second-side outer end of the driving battery in the vehicle width direction can be enlarged in the vehicle width direction to reach the vicinity of the second-side rocker.

In the electrically powered vehicle of the present disclosure, the body may include a floor panel laid out between the first-side rocker and the second-side rocker, a cross member connected to an upper surface of the floor panel and connecting the first-side rocker and the second-side rocker in the vehicle width direction, and at least one base connected to a lower surface of a first-side vehicle side portion of the floor panel, the at least one base may be disposed adjacent to the pipe toward an inner side of the pipe in the vehicle width direction and connected to the cross member with the floor panel interposed therebetween, and the first-side outer end of the driving battery in the vehicle width direction may extend in the vehicle width direction to reach a vicinity of the pipe and may be connected to the at least one base.

This enables absorption of impact energy through deformation of a cross member upon a side collision of the electrically powered vehicle on the first side. Also, as the base can be disposed in the vehicle side portion on the first side to be adjacent to the pipe, the first-side outer end of the driving battery in the vehicle width direction can be enlarged in the vehicle width direction to reach the vicinity of the pipe.

In the electrically powered vehicle of the present disclosure, the at least one base may be disposed adjacent to the pipe and, as viewed from below the vehicle, a portion of the at least one base may overlap the pipe in the vehicle width direction.

With this configuration, the first-side outer end of the driving battery in the vehicle width direction can be further enlarged in the vehicle width direction.

In the electrically powered vehicle of the present disclosure, the at least one base may extend toward the first-side rocker in the vehicle width direction and may be connected to the first-side rocker, and the at least one base may include at least one fragile portion.

This enables absorption of impact energy upon a side collision on the first side by the fragile portion, thus increasing the amount of absorption of impact energy to thereby suppress entry of a pole (an object against which the vehicle collides).

The electrically powered vehicle of the present disclosure may further comprise a connecting member that connects between the at least one base and the first-side rocker in the vehicle width direction, and the connecting member may include at least one fragile portion.

This enables absorption of impact energy upon a side collision on the first side by the fragile portion, thus increasing the amount of absorption of impact energy to thereby suppress entry of the pole.

In the electrically powered vehicle of the present disclosure, a first-side outer surface of the driving battery in the vehicle width direction may be a vertical wall that opposes the pipe, and the lower end of the vertical wall may be located more toward a lower side of the vehicle than a center of the pipe.

As the pipe is pressed between the vertical wall and the first-side rocker, this configuration enables collapse of the pipe upon a side collision on the first side, thereby increasing the amount of absorption of impact energy to suppress entry of the pole.

In the electrically powered vehicle of the present disclosure, the pipe may extend in the vehicle longitudinal direction in a first-side vehicle side portion of the body, and the second-side impact absorbing member may be disposed between a second-side outer end of the driving battery in the vehicle width direction and a second-side outer end of the body in the vehicle width direction, and the first-side impact absorbing member may be disposed between a first-side outer end of the driving battery in the vehicle width direction and the pipe.

This enables an increased length of the driving battery in the vehicle width direction, as this configuration can shorten the length between the second-side outer end of the driving battery in the vehicle width direction and the second-side outer end of the body in the vehicle width direction and the length between the first-side outer end of the driving battery in the vehicle width direction and the pipe.

In the electrically powered vehicle of the present disclosure, the body may include a first-side rocker disposed in the first-side vehicle side portion of the body and extending in the vehicle longitudinal direction, a second-side rocker disposed in a second-side vehicle side portion of the body and extending in the vehicle longitudinal direction, a floor panel laid out between the first-side rocker and the second-side rocker, a cross member connected to an upper surface of the floor panel and connecting the first-side rocker and the second-side rocker in the vehicle width direction, and at least one base connected to a lower surface of a first-side vehicle side portion of the floor panel and connected to the cross member with the floor panel interposed therebetween, the at least one base may be disposed adjacent to the pipe toward an inner side of the pipe in the vehicle width direction and connected to the cross member with the floor panel interposed therebetween, and the first-side impact absorbing member may connect between a lower portion of the at least one base and the first-side outer end of the driving battery in the vehicle width direction, the first-side outer end of the driving battery in the vehicle width direction may extend in the vehicle width direction to reach a vicinity of the pipe and may be connected to the at least one base, the second-side impact absorbing member may connect between a lower portion of the second-side rocker and the second-side outer end of the driving battery in the vehicle width direction, and the second-side outer end of the driving battery in the vehicle width direction may extend in the vehicle width direction to reach a vicinity of the second-side rocker.

This enables absorption of impact energy upon a side collision on the second side by allowing the second-side impact absorbing member to collapse as a shock load input from the second-side rocker upon the side collision is received by the driving battery having high strength. Therefore, as less space is required for absorbing impact energy in the side portion of the body, the second-side outer end of the driving battery in the vehicle width direction can be enlarged to reach the vicinity of the second-side rocker. Also, as impact energy can be absorbed upon a side collision of the electrically powered vehicle on the first side through deformation of the cross member and by the first-side impact absorbing member, the distance of entry of the pole upon the side collision can be reduced. Also, as the base can be disposed in the vehicle side portion on the first side to be adjacent to the pipe, the first-side outer end of the driving battery in the vehicle width direction can be enlarged in the vehicle width direction to reach the vicinity of the pipe.

The electrically powered vehicle of the present disclosure may further comprise a wall member connected to the at least one base and extending in the vehicle longitudinal direction, and the first-side impact absorbing member may connect between the wall member and the first-side outer end of the driving battery in the vehicle width direction.

This allows the pipe to be pressed between the wall member and the first-side rocker and collapse upon a side collision on the first side, thereby enabling absorption of impact energy. Therefore, an increase in amount of absorption of impact energy can suppress entry of the pole upon a side collision.

In the electrically powered vehicle of the present disclosure, the lower end of the wall member may be located more toward a lower side of the vehicle than a center of the pipe.

This allows the pipe to be reliably pressed between the wall member and the first-side rocker and collapse upon a side collision on the first side. This reliably enables an increase in amount of absorption of impact energy, thereby reducing the distance of entry of the pole.

The present disclosure provides an electrically powered vehicle that enables an increased length of a driving battery in the vehicle width direction while ensuring absorption of impact energy upon a side collision.

### BRIEF DESCRIPTION OF DRAWINGS

Embodiments of the present disclosure will be described based on the following figures, wherein:

FIG. 1 is a bottom view of an electrically powered vehicle according to an embodiment;

FIG. 2 is an elevation cross-sectional view of a left-hand side portion of the electrically powered vehicle according to the embodiment, the cross section taken along line A-A in FIG. 1;

FIG. 3 is an elevation cross-sectional view of a right-hand side portion of the electrically powered vehicle according to the embodiment, the cross section taken along line B-B in FIG. 1;

FIG. 4 is a bottom view of a right-hand side portion of an electrically powered vehicle according to a second embodiment;

FIG. 5 is an elevation cross-sectional view of the right-hand side portion of the electrically powered vehicle according to the second embodiment, the cross section taken along line C-C in FIG. 4;

FIG. 6 is a bottom view of a right-hand side portion of an electrically powered vehicle according to a third embodiment;

FIG. 7 is an elevation cross-sectional view of the right-hand side portion of the electrically powered vehicle according to the third embodiment, the cross section taken along line D-D in FIG. 6;

FIG. 8 is an elevation cross-sectional view of a right-hand side portion of an electrically powered vehicle according to a fourth embodiment;

FIG. 9 is a bottom view of an electrically powered vehicle according to a fifth embodiment;

FIG. 10 is an elevation cross-sectional view of a right-hand side portion of the electrically powered vehicle according to the fifth embodiment, the cross section taken along line E-E in FIG. 9;

FIG. 11 is a bottom view of a right-hand side portion of an electrically powered vehicle according to a sixth embodiment;

FIG. 12 is an elevation cross-sectional view of the right-hand side portion of the electrically powered vehicle according to the sixth embodiment, the cross section taken along line F-F in FIG. 11;

FIG. 13 is a bottom view of a right-hand side portion of an electrically powered vehicle according to a seventh embodiment; and

FIG. 14 is an elevation cross-sectional view of the right-hand side portion of the electrically powered vehicle according to the seventh embodiment, the cross section taken along line G-G in FIG. 13.

### DESCRIPTION OF EMBODIMENTS

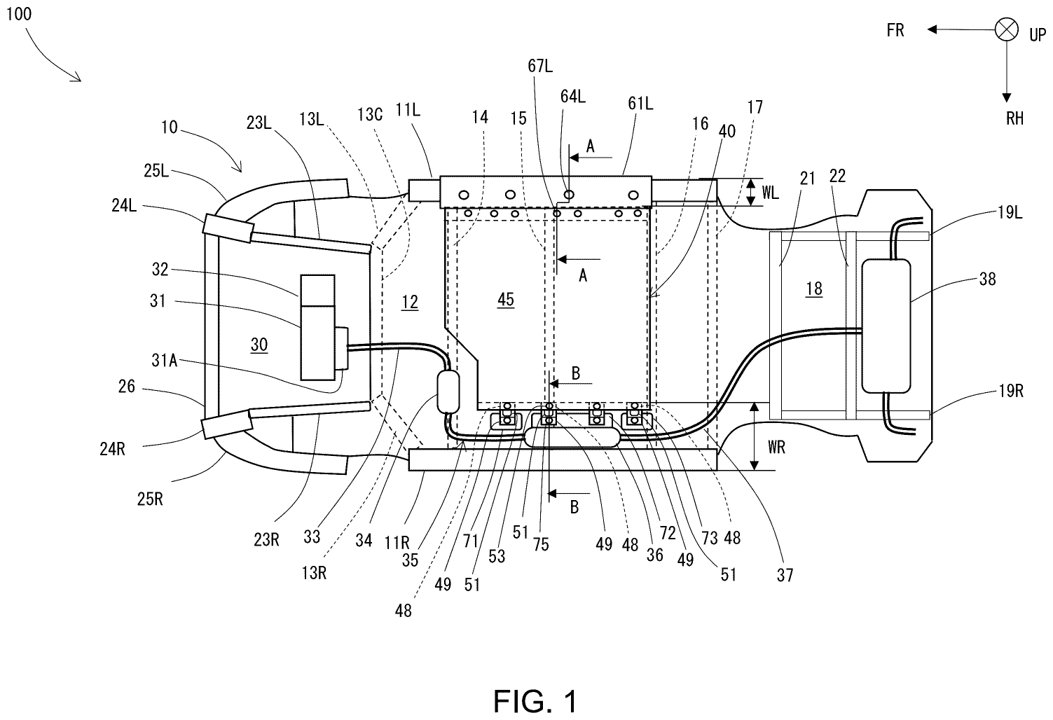

By reference to the accompanying drawings, an electrically powered vehicle 100 according to an embodiment of the present disclosure will be described below. As illustrated in FIG. 1, the electrically powered vehicle 100 is a hybrid electric vehicle that incorporates an engine 31 serving as the internal combustion engine, a driving motor 32, and a driving battery 40. The electrically powered vehicle 100 can travel in hybrid mode in which it travels using outputs from the engine 31 and the driving motor 32, and in electrically powered mode in which it travels as the driving motor 32 is driven by power supplied from the driving battery 40. In the drawings, FR, UP, and RH respectively represent the front side, the upper side, and the right-hand side of an electrically powered vehicle 100, 110, 120, 130, 140, 150, or 160. The directions opposite to FR, UP, and RH respectively represent the rear side, the lower side, and the left-hand side. In the following description, unless otherwise specified, simply using front, rear, right, left, up, and down directions indicates the front and the rear of the electrically powered vehicle 100, 110, 120, 130, 140, 150, or 160 in the longitudinal direction, the right-hand side and the left-hand side of the electrically powered vehicle 100, 110, 120, 130, 140, 150, or 160 in the width direction, and the upside and the downside of the electrically powered vehicle 100, 110, 120, 130, 140, 150, or 160 in the vertical direction. Note that the present specification uses the term “first-side” to refer to the right side and the term “second-side” to refer to the left side.

As illustrated in FIG. 1, the electrically powered vehicle 100 includes a body 10, the engine 31, the driving motor 32, the driving battery 40, an exhaust pipe 35, and a left impact absorbing member 61L. Note that the left impact absorbing member 61L serves as the second-side impact absorbing member.

The body 10 includes right and left rockers 11R and 11L, a floor panel 12, right and left reinforcement members 13R and 13L, a center reinforcement member 13C, and first, second, third, and fourth cross members 14, 15, 16, and 17. Note that the right rocker 11R serves as the first-side rocker and that the left rocker 11L serves as the second-side rocker. The body 10 also includes, in the front, right and left front side members 23R and 23L, right and left crash boxes 24R and 24L, right and left upper members 25R and 25L, and a bumper reinforcement 26. The body 10 further includes, in the rear, a rear floor panel 18, right and left rear side members 19R and 19L, and first and second rear cross members 21 and 22.

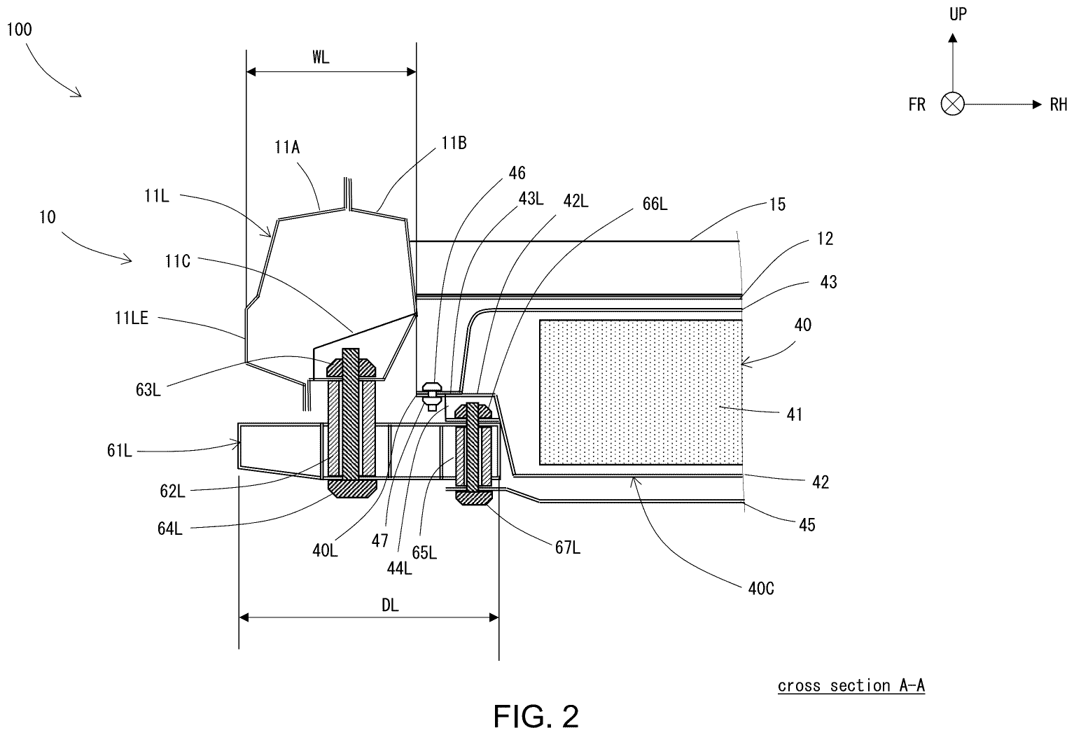

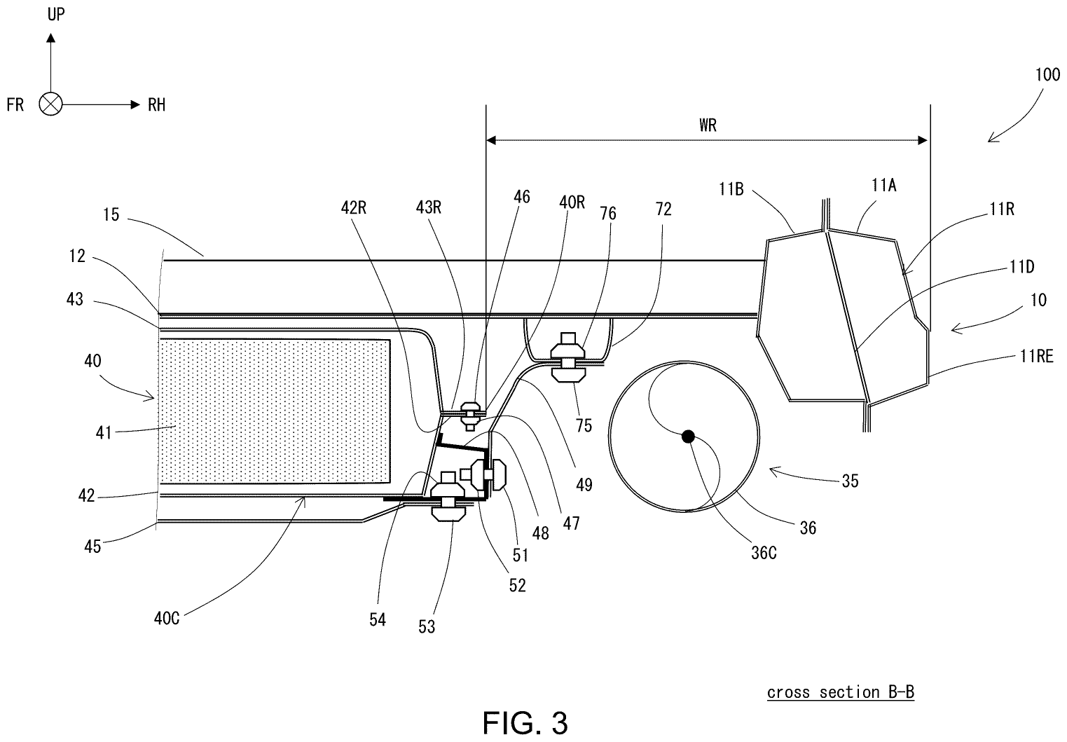

The right and left rockers 11R and 11L are frame members that are disposed in right and left vehicle side portions of the body 10 and extend in the vehicle longitudinal direction. As illustrated in FIGS. 2 and 3, the right and left rockers 11R and 11L are members each having a generally quadrangular closed cross section and composed of a combination of an outer member 11A and an inner member 11B each having a generally groove-shaped cross section. As illustrated in FIG. 2, the left rocker 11L includes a plurality of brackets 11C within the inner member 11B. The plurality of brackets 11C are disposed at positions where bolts 64L, which will be described below, are inserted. As illustrated in FIG. 3, the right rocker 11R includes a reinforcement plate 11D that extends in the vertical direction.

As illustrated in FIG. 1, the floor panel 12 is a flat member that is laid out between the right and left rockers 11R and 11L. As illustrated in FIGS. 2 and 3, the second cross member 15 is connected to an upper surface of the floor panel 12 and connects between the left rocker 11L and the right rocker 11R in the vehicle width direction. The second cross member 15 may be, for example, a hat-shaped cross section member which is open downward. Similarly as for the second cross member 15, the first, third, and fourth cross members 14, 16, and 17 are connected to the upper surface of the floor panel 12 and connect between the left rocker 11L and the right rocker 11R in the vehicle width direction.

The right and left reinforcement members 13R and 13L connect between the respective front portions of the right and left rockers 11R and 11L and the respective rear portions of the right and left front side members 23R and 23L in diagonal directions. The center reinforcement member 13C connects between vehicle width direction inner side ends of the right and left reinforcement members 13R and 13L in the vehicle width direction. The floor panel 12 has, in its center portion, a front end that extends toward the front to reach the center reinforcement member 13C. The floor panel 12 has, in its right and left side portions, front ends that extend toward the front of the vehicle beyond the right and left reinforcement members 13R and 13L. The right and left reinforcement members 13R and 13L and the center reinforcement member 13C are connected to the upper surface of the floor panel 12.

The right and left crash boxes 24R and 24L are connected to front ends of the right and left front side members 23R and 23L. The bumper reinforcement 26 connects between the right and left crash boxes 24R and 24L in the vehicle width direction.

The right and left rear side members 19R and 19L are frame members that are attached to a lower surface of the rear floor panel 18 and extend in the vehicle longitudinal direction. The first and second rear cross members 21 and 22 are connected to the lower surface of the rear floor panel 18 and connect between the right and left rear side members 19R and 19L in the vehicle width direction.

An area more toward the front of the vehicle than the center reinforcement member 13C is a front compartment 30. The engine 31 and the driving motor 32 are installed within the front compartment 30. The exhaust pipe 35 is connected to an exhaust manifold 31A of the engine 31. The exhaust pipe 35 is a pipe configured to discharge exhaust from the engine 31 to the outside.

The exhaust pipe 35 includes a front exhaust pipe 33, a rear exhaust pipe 37, a first large diameter section 34, and a second large diameter section 36. An exhaust silencer 38 is connected to a rear end of the rear exhaust pipe 37. The front exhaust pipe 33 extends from the exhaust manifold 31A toward the rear of the vehicle, then curves toward a right-hand side portion of the vehicle to extend to the right-hand side portion of the vehicle, and then extends along the right rocker 11R toward the rear of the vehicle to be connected to the second large diameter section 36. The first large diameter section 34 is disposed at some midpoint in the front exhaust pipe 33. The second large diameter section 36 is disposed in a center portion in the vehicle longitudinal direction and extends along the right rocker 11R in the vehicle longitudinal direction. The rear exhaust pipe 37 curves in the shape like a letter S from the second large diameter section 36 toward the center in the vehicle width direction and is then connected to the exhaust silencer 38. The exhaust silencer 38 is disposed on the lower surface of the rear floor panel 18 in the center in the vehicle width direction.

As illustrated in FIG. 1, the driving battery 40 is disposed toward the left side of the body 10 so that a length WL is shorter than a length WR. The length WL is a length between a left-side outer end 40L of the driving battery 40 in the vehicle width direction (see FIG. 2) and a left-side outer end of the body 10 in the vehicle width direction. The length WR is a length between a right-side outer end 40R of the driving battery 40 in the vehicle width direction (see FIG. 3) and a right-side outer end of the body 10 in the vehicle width direction. As illustrated in FIGS. 2 and 3, the driving battery 40 is disposed below the floor panel 12 of the body 10.

Specifically, as illustrated in FIGS. 2 and 3, the driving battery 40 includes a cell 41 and a casing 40C that houses the cell 41. The casing 40C includes a lower casing 42 and an upper casing 43. As illustrated in FIG. 2, the lower casing 42 and the upper casing 43 include a lower left flange 42L and an upper left flange 43L that extend from a left-hand side portion toward the outside in the vehicle width direction. The lower left flange 42L and the upper left flange 43L are fastened together with bolts 46 and nuts 47. A left end of the lower left flange 42L and a left end of the upper left flange 43L constitute the left-side outer end 40L of the driving battery 40 in the vehicle width direction. The left-side outer end 40L of the driving battery 40 in the vehicle width direction extends toward the outside in the vehicle width direction to reach the vicinity of the left rocker 11L. On the other hand, as illustrated in FIG. 2, a left end surface 11LE of the left rocker 11L constitutes the left-side outer end of the body 10 in the vehicle width direction. As such, the length WL represents a length between the left ends of the lower left flange 42L and the upper left flange 43L and the left end surface 11LE of the left rocker 11L.

Similarly, as illustrated in FIG. 3, the lower casing 42 and the upper casing 43 include a lower right flange 42R and an upper right flange 43R that extend from a right-hand side portion toward the outside in the vehicle width direction. The lower right flange 42R and the upper right flange 43R are fastened together with bolts 46 and nuts 47. A right end of the lower right flange 42R and a right end of the upper right flange 43R constitute the right-side outer end 40R of the driving battery 40 in the vehicle width direction. On the other hand, as illustrated in FIG. 3, a right end surface 11RE of the right rocker 11R constitutes the right-side outer end of the body 10 in the vehicle width direction. As such, the length WR represents a length between the right ends of the lower right flange 42R and the upper right flange 43R and the right end surface 11RE of the right rocker 11R. As illustrated in FIGS. 1 to 3, the driving battery 40 is disposed toward the left side of the body 10 so that the length WL is shorter than the length WR.

The lower left flange 42L of the lower casing 42 has, on its lower surface, a left leg 44L that protrudes downward. A plurality of left legs 44L are provided in the vehicle longitudinal direction. As illustrated in FIGS. 1 and 2, the left impact absorbing member 61L that connects between a lower portion of the left rocker 11L and the left-side outer end 40L of the driving battery 40 in the vehicle width direction is disposed below the left rocker 11L. When viewed from the driving battery 40, the left impact absorbing member 61L is disposed toward the left-side outside of the driving battery 40 in the vehicle width direction. The left impact absorbing member 61L is an elongated member having a flattened quadrangular closed cross section and extending in the vehicle longitudinal direction. The left impact absorbing member 61L has a length DL in the vehicle width direction. The left impact absorbing member 61L is partitioned into a plurality of chambers in the vehicle width direction and, upon a collision, absorbs impact energy as the chambers collapse in the vehicle width direction.

The left impact absorbing member 61L is attached below the left rocker 11L with the bolts 64L, sleeves 62L, and nuts 63L. The casing 40C of the driving battery 40 is placed on an upper surface of the left impact absorbing member 61L so that the left leg 44L attached to the lower surface of the lower left flange 42L is in contact with an upper surface of an end of the left impact absorbing member 61L located toward the center in the vehicle width direction. The end of the left impact absorbing member 61L located toward the center in the vehicle width direction and the left leg 44L are connected together and fixed with bolts 67L, sleeves 65L, and nuts 66L. A left end of the driving battery 40 is supported by the left rocker 11L with the left impact absorbing member 61L interposed therebetween.

A right side surface of the casing 40C located below the lower right flange 42R has an arm 48 that protrudes from the right side surface of the casing 40C toward the right. A plurality of arms 48 are provided in the vehicle longitudinal direction.

As illustrated in FIGS. 1 and 3, a plurality of bases 71, 72, and 73 are attached to a lower surface of a right-side vehicle side portion of the floor panel 12. The plurality of bases 71, 72, and 73 are groove-shaped cross section members that are open upward and protrude downward from the lower surface of the floor panel 12. The plurality of bases 71, 72, and 73 are attached to be aligned straight in the vehicle longitudinal direction. As illustrated in FIGS. 1 and 3, the center base 72 is disposed adjacent to the second large diameter section 36 of the exhaust pipe 35 toward the inside in the vehicle width direction. The base 72 is disposed adjacent to the second large diameter section 36 so that, as viewed from below the vehicle, a portion of the base 72 overlaps the second large diameter section 36 in the vehicle width direction.

The second cross member 15 is connected to the upper surface of the floor panel 12. As such, the base 72 is connected to the second cross member 15 with the floor panel 12 interposed therebetween. Similarly, the front base 71 is disposed adjacent to the front exhaust pipe 33 of the exhaust pipe 35 toward the inside in the vehicle width direction. The base 71 is connected to the first cross member 14 and the second cross member 15 with the floor panel 12 interposed therebetween. The rear base 73 is disposed adjacent to the rear exhaust pipe 37 toward the inside in the vehicle width direction. The base 73 is connected to the third cross member 16 with the floor panel 12 interposed therebetween.

As illustrated in FIG. 3, the base 72 and the arm 48, which is attached to the right end surface of the lower casing 42, are connected together with a bracket 49. An upper end of the bracket 49 is fastened to the base 72 using a bolt 75 and a nut 76. A lower end of the bracket 49 is fastened to the right end surface of the arm 48 using a bolt 51 and a nut 52. Similarly, as illustrated in FIG. 1, the front base 71 is connected to the front arm 48 with a bracket 49, and the rear base 73 is connected to the rear arm 48 with a bracket 49. As described above, the plurality of arms 48 attached to the lower casing 42 are connected to the bases 71, 72, and 73 with the brackets 49. The bases 71, 72, and 73 are connected to the first, second, and third cross members 14, 15, and 16 with the floor panel 12 interposed therebetween, and the right ends of the first, second, and third cross members 14, 15, and 16 are connected to the right rocker 11R. As such, the right end of the driving battery 40 is supported by the right rocker 11R with the brackets 49, the bases 71, 72, and 73, the floor panel 12, and the first, second, and third cross members 14, 15, and 16 interposed therebetween. As the bases 71, 72, and 73 are disposed adjacent to the exhaust pipe 35 toward the inside in the vehicle width direction, the right-side outer end 40R of the driving battery 40 in the vehicle width direction extends toward the outside in the vehicle width direction to reach the vicinity of the exhaust pipe 35.

As illustrated in FIGS. 2 and 3, a shear panel 45 is attached below the casing 40C. The shear panel 45 is a flat member for receiving an impactive force coming from below. The left end of the shear panel 45 is attached with the bolts 67L to the end of the left impact absorbing member 61L located toward the center in the vehicle width direction. The right end of the shear panel 45 is fastened to the lower surface of the arm 48 using a bolt 53 and a nut 54.

In the electrically powered vehicle 100 having the above-described configuration, the left impact absorbing member 61L is disposed toward the outside in the vehicle width direction on the left side of the driving battery 40. The lower portion of the left rocker 11L and the left-side outer end 40L of the driving battery 40 in the vehicle width direction are connected by the left impact absorbing member 61L. This allows the left impact absorbing member 61L to collapse upon a side collision of the electrically powered vehicle 100 on the left side, as a shock load input from the left rocker 11L is received by the casing 40C of the driving battery 40 having high strength. This enables absorption of impact energy upon a side collision. Therefore, it is unnecessary to provide space for absorbing impact energy in the left-hand side portion of the body 10. As a result, the left-side outer end 40L of the driving battery 40 in the vehicle width direction can be enlarged toward the outside in the vehicle width direction to reach the vicinity of the left rocker 11L, thereby increasing the length of the driving battery 40 in the vehicle width direction.

In the electrically powered vehicle 100, as illustrated in FIG. 1, the driving battery 40 is disposed toward the left side of the body 10 so that the length WL is shorter than the length WR. With this configuration, the exhaust pipe 35 can be disposed toward the outside in the vehicle width direction on the right side of the driving battery 40. The driving battery 40 may have an increased length in the vehicle width direction.

In the electrically powered vehicle 100, the right end of the driving battery 40 is supported by the right rocker 11R with the brackets 49, the bases 71, 72, and 73, the floor panel 12, and the first, second, and third cross members 14, 15, and 16 interposed therebetween. This enables absorption of impact energy input from the right rocker 11R upon a side collision of the electrically powered vehicle 100 on the right side through deformation of the first, second, and third cross members 14, 15, and 16. As the bases 71, 72, and 73 are disposed in the vehicle side portion on the right side to be adjacent to the exhaust pipe 35, the right-side outer end 40R of the driving battery 40 in the vehicle width direction can be enlarged in the vehicle width direction to reach the vicinity of the exhaust pipe 35.

Additionally, in the electrically powered vehicle 100, the base 72 is disposed adjacent to the second large diameter section 36 so that a portion of the base 72 overlaps the second large diameter section 36 in the vehicle width direction. With this configuration, the right-side outer end 40R of the driving battery 40 in the vehicle width direction can be further enlarged in the vehicle width direction to reach the vicinity of the exhaust pipe 35.

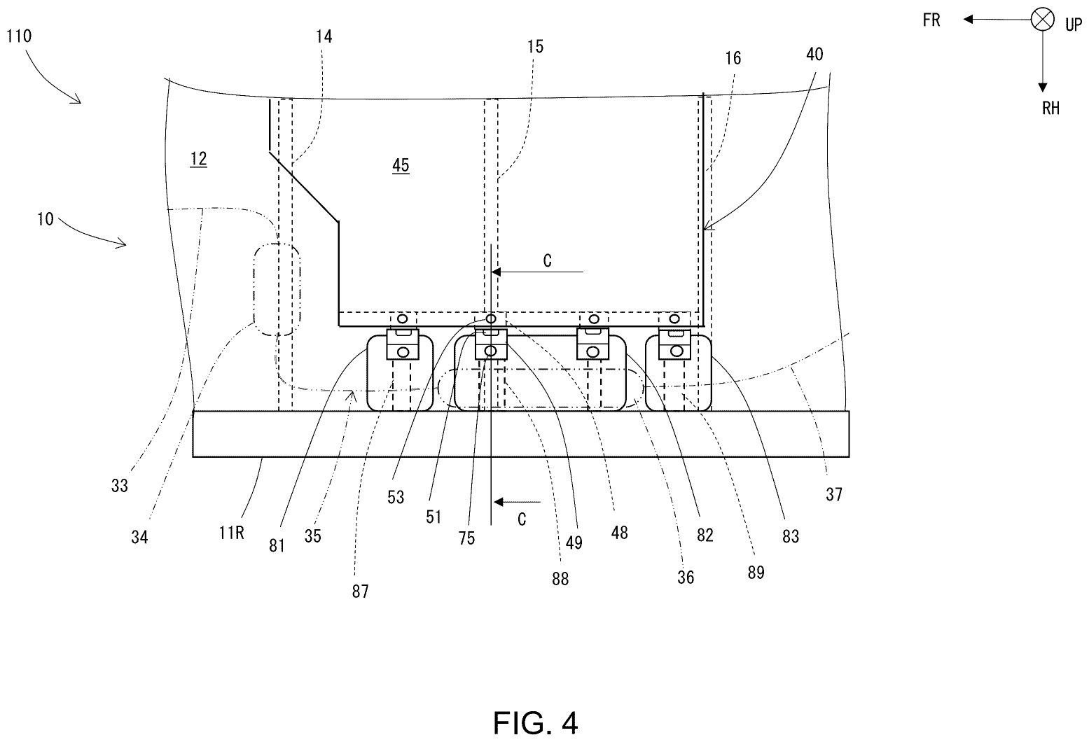

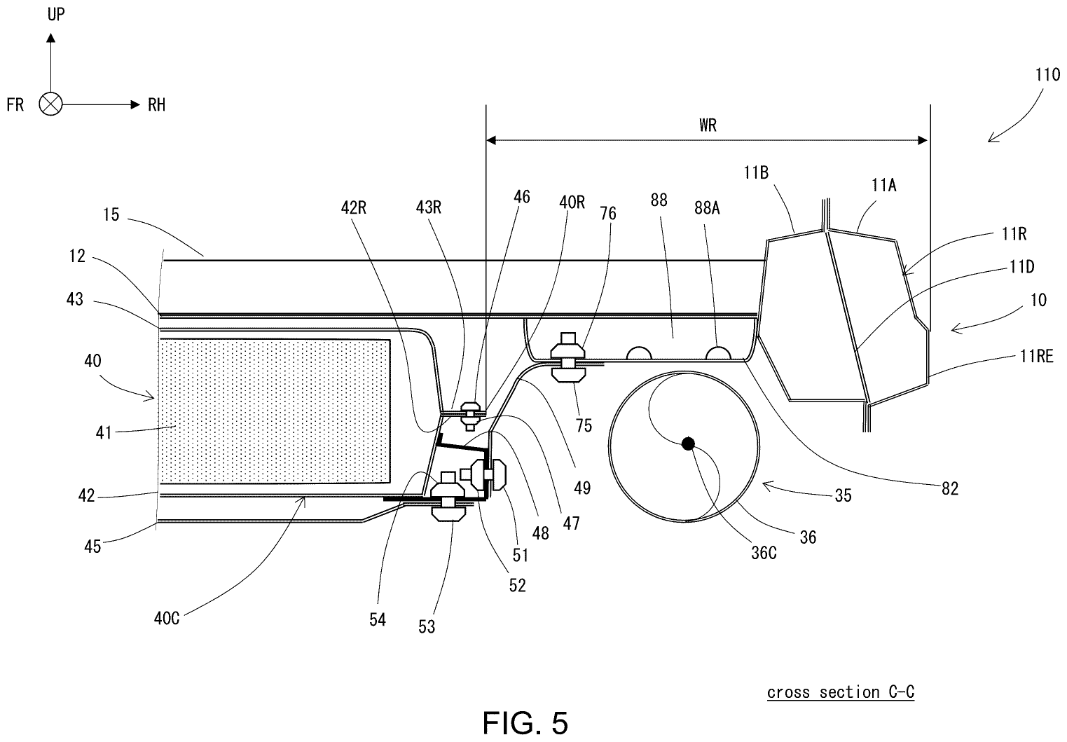

Referring next to FIGS. 4 and 5, an electrically powered vehicle 110 according to another embodiment will be described below. The same portions as those of the electrically powered vehicle 100 described above with reference to FIGS. 1 to 3 are denoted by the same reference numerals, and their description is not repeated here.

As illustrated in FIGS. 4 and 5, the electrically powered vehicle 110 includes, instead of the bases 71, 72, and 73 of the electrically powered vehicle 100, bases 81, 82, and 83 that extend toward the right rocker 11R in the vehicle width direction to connect to the right rocker 11R.

As illustrated in FIGS. 4 and 5, the bases 81, 82, and 83 have groove-shaped cross sections that are open upward, each having a bracket 49 connected to a portion located toward the center in the vehicle width direction, and a right end extending to the right rocker 11R and connected to the right rocker 11R. The base 82 has therein a reinforcement plate 88 that extends in the vehicle width direction to connect between right and left flanges. The reinforcement plate 88 has a notch 88A. Similarly, the bases 81 and 83 have therein reinforcement plates 87 and 89, and the reinforcement plates 87 and 89 also have notches (not illustrated). The notch portions of the reinforcement plates 87, 88, and 89 constitute fragile portions of the bases 81, 82, and 83.

Upon a side collision of the electrically powered vehicle 110 having the above-described configuration on the right side, impact energy input from the right rocker 11R can be absorbed not only through deformation of the first, second, and third cross members 14, 15, and 16 but also through collapse of the fragile portions of the bases 81, 82, and 83. Therefore, an increase in amount of absorption of impact energy may reduce the distance of entry of the pole upon a side collision.

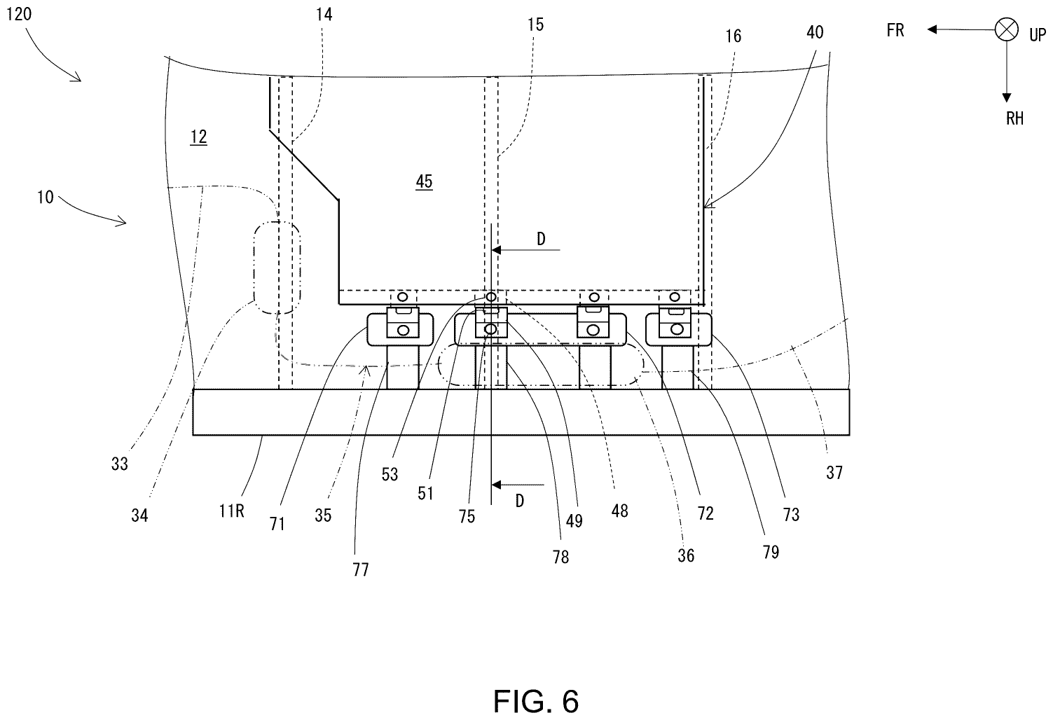

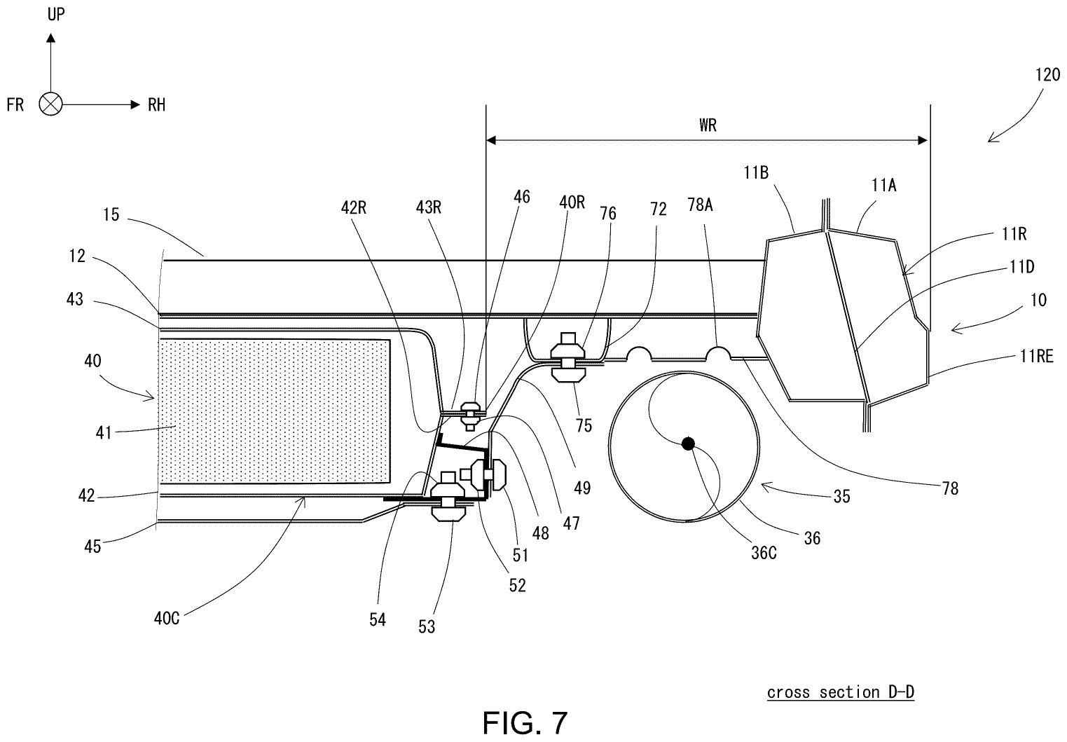

Referring next to FIGS. 6 and 7, an electrically powered vehicle 120 according to another embodiment will be described below. The same portions as those of the electrically powered vehicle 100 described above with reference to FIGS. 1 to 3 are denoted by the same reference numerals, and their description is not repeated here.

As illustrated in FIGS. 6 and 7, the electrically powered vehicle 120 includes connecting members 77, 78, and 79 that connect between the right ends of the bases 71, 72, and 73 and the right rocker 11R.

As illustrated in FIGS. 6 and 7, the connecting members 77, 78, and 79 are elongated members having groove-shaped cross sections that are open upward and extend in the vehicle width direction. The connecting members 77, 78, and 79 are connected to the lower surface of the floor panel 12. The connecting member 78 has a notch 78A on its lower surface. Similarly, the connecting members 77 and 79 also have notches on their lower surfaces (not illustrated). The portions of the connecting members 77, 78, and 79 where the notches are provided constitute fragile portions of the connecting members 77, 78, and 79.

In the electrically powered vehicle 120, as in the electrically powered vehicle 110, upon a side collision on the right side, impact energy can be absorbed through collapse of the fragile portions of the connecting members 77, 78, and 79. Therefore, an increase in amount of absorption of impact energy upon a side collision may reduce the distance of entry of the pole.

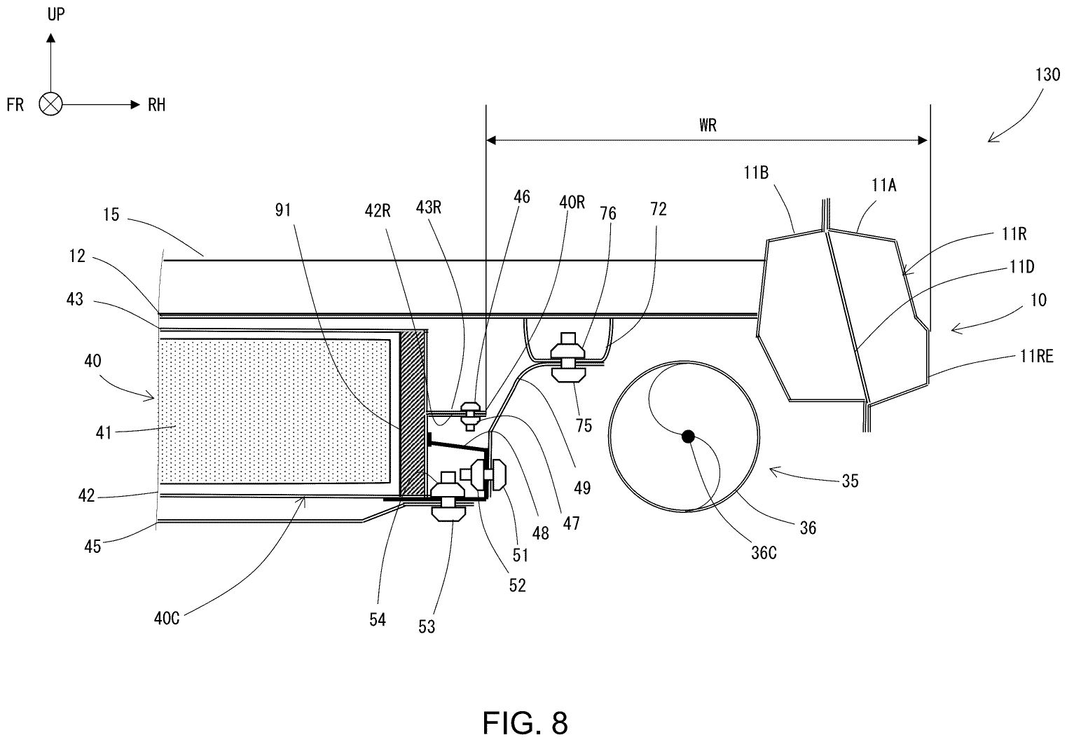

Referring next to FIG. 8, an electrically powered vehicle 130 according to another embodiment will be described below. The same portions as those of the electrically powered vehicle 100 described above with reference to FIGS. 1 to 3 are denoted by the same reference numerals, and their description is not repeated here.

As illustrated in FIG. 8, in the electrically powered vehicle 130, the right end surface of the casing 40C of the driving battery 40 serves as a vertical wall 91 that opposes the second large diameter section 36 of the exhaust pipe 35. The right end surface of the casing 40C constitutes the right-side outer surface of the driving battery 40 in the vehicle width direction. The lower end of the vertical wall 91 extends more toward the lower side of the vehicle than the center 36C of the second large diameter section 36.

This enables absorption of impact energy upon a side collision on the right side as the second large diameter section 36 of the exhaust pipe 35 is collapsed by the vertical wall 91. Therefore, an increase in amount of absorption of impact energy upon a side collision may reduce the distance of entry of the pole (an object against which the vehicle collides).

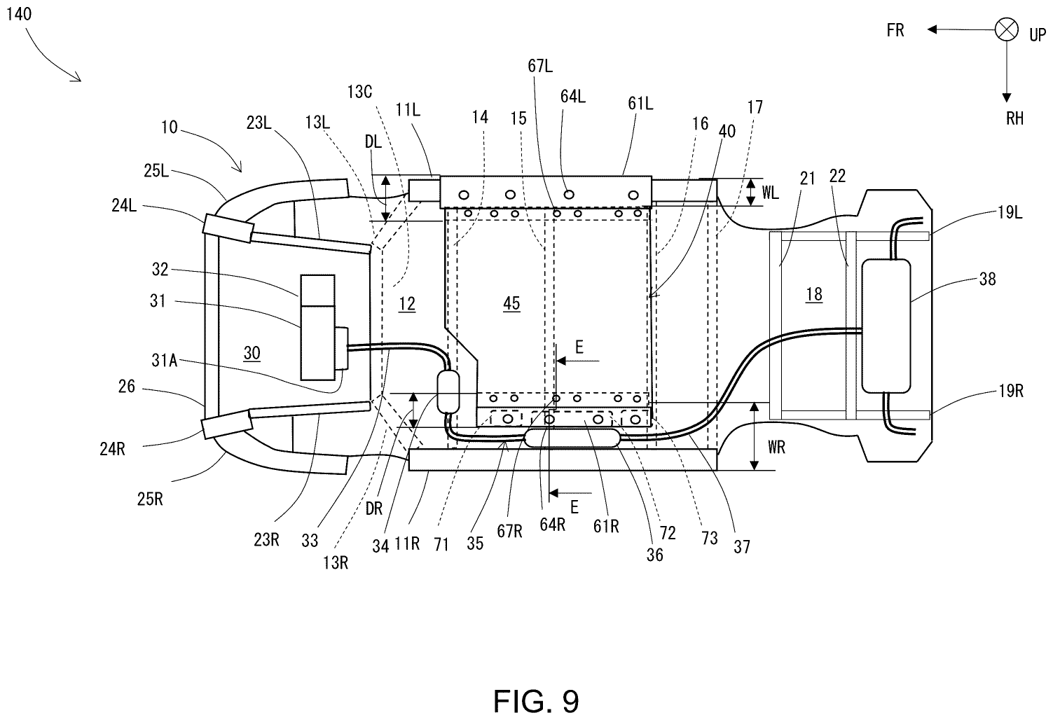

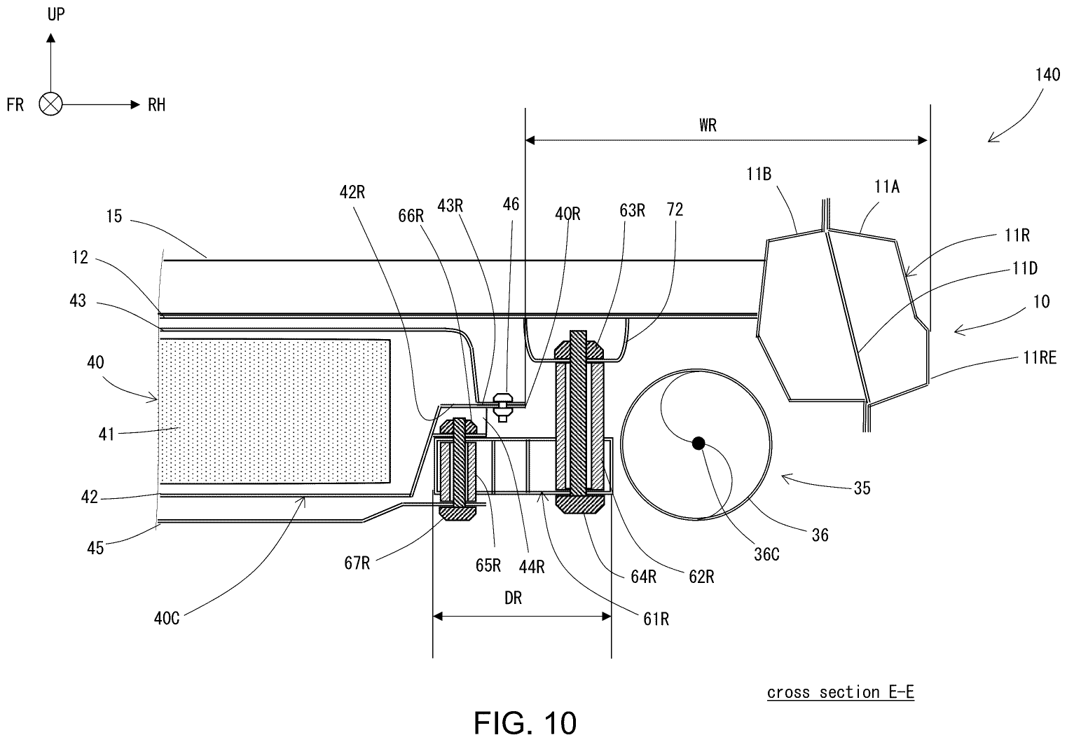

Referring next to FIGS. 9 and 10, an electrically powered vehicle 140 according to another embodiment will be described below. The same portions as those of the electrically powered vehicle 100 described above with reference to FIGS. 1 to 3 are denoted by the same reference numerals, and their description is not repeated here.

As illustrated in FIGS. 9 and 10, the electrically powered vehicle 140 includes, instead of the arms 48 and the brackets 49 of the electrically powered vehicle 100, a right leg 44R, a right impact absorbing member 61R, bolts 64R and 67R, nuts 63R and 66R, and sleeves 62R and 65R. The right impact absorbing member 61R constitutes the first-side impact absorbing member.

As illustrated in FIGS. 9 and 10, the lower right flange 42R of the lower casing 42 has, on its lower surface, the right leg 44R that protrudes downward. A plurality of right legs 44R are provided in the vehicle longitudinal direction. The right impact absorbing member 61R is disposed toward the right-side outside of the driving battery 40 in the vehicle width direction. Similarly as for the left impact absorbing member 61L, the right impact absorbing member 61R is an elongated member having a flattened quadrangular closed cross section and extending in the vehicle longitudinal direction. Similarly as for the left impact absorbing member 61L, the right impact absorbing member 61R is partitioned into a plurality of chambers in the vehicle width direction and, upon a collision, absorbs impact energy as the chambers collapse in the vehicle width direction. The right impact absorbing member 61R has a length DR in the vehicle width direction, the length DR being shorter than the length DL of the left impact absorbing member 61L.

The right impact absorbing member 61R connects between lower portions of the bases 71, 72, and 73 and the right-side outer end 40R of the driving battery 40 in the vehicle width direction. The right impact absorbing member 61R is attached below the bases 71, 72, and 73 with the bolts 64R, the sleeves 62R, and the nuts 63R. The casing 40C of the driving battery 40 is placed on an upper surface of the right impact absorbing member 61R so that the right leg 44R attached to the lower surface of the lower right flange 42R is in contact with an upper surface of an end of the right impact absorbing member 61R located toward the center in the vehicle width direction. The end of the right impact absorbing member 61R located toward the center in the vehicle width direction and the right leg 44R are connected together and fixed with the bolts 67R, the sleeves 65R, and the nuts 66R. A right end of the driving battery 40 is supported by the bases 71, 72, and 73 with the right impact absorbing member 61R, the bolts 64R, the sleeves 62R, and the nuts 63R interposed therebetween.

Upon a side collision of the electrically powered vehicle 140 having the above-described configuration on the right side, impact energy input from the right rocker 11R can be absorbed through deformation of the first, second, and third cross members 14, 15, and 16 and can be absorbed through collapse of the right impact absorbing member 61R. Therefore, an increase in amount of absorption of impact energy may reduce the distance of entry of the pole upon a side collision.

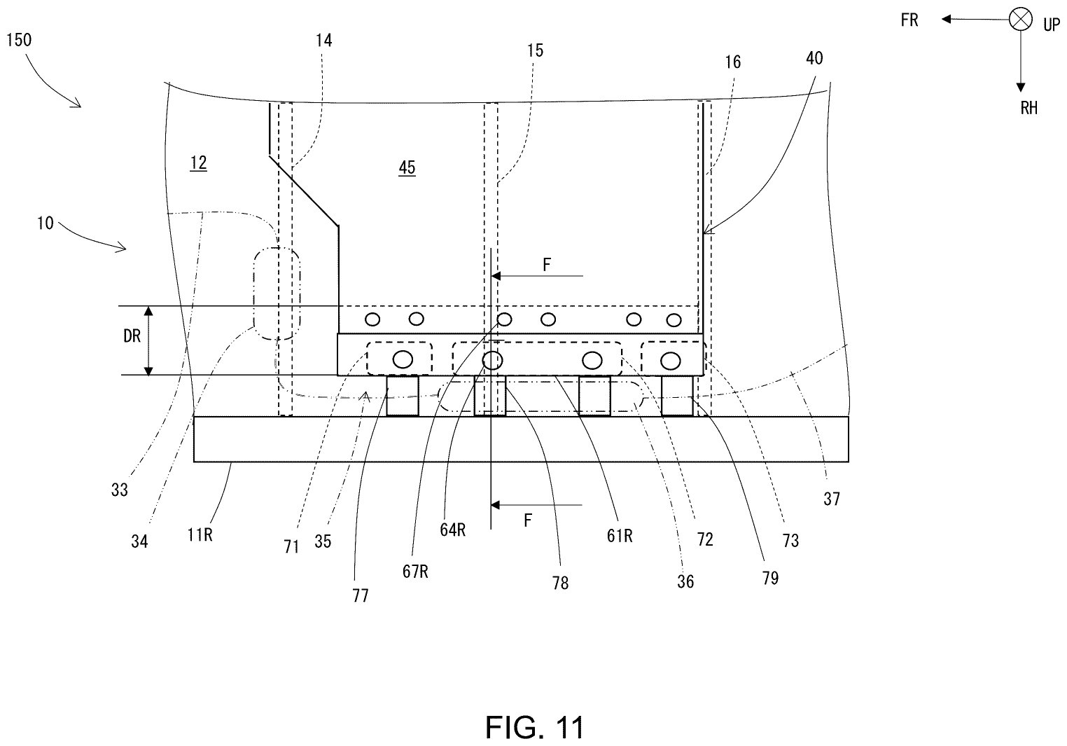

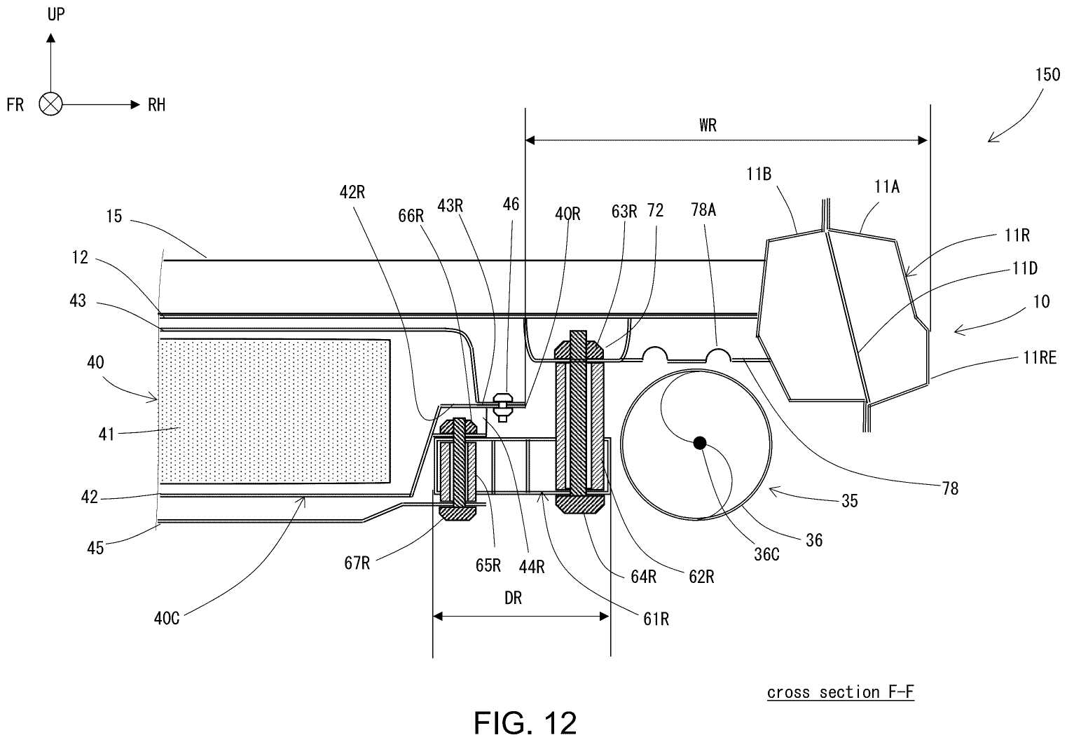

Referring next to FIGS. 11 and 12, an electrically powered vehicle 150 according to another embodiment will be described below. The same portions as those of the electrically powered vehicle 140 described above with reference to FIGS. 9 and 10 are denoted by the same reference numerals, and their description is not repeated here.

As illustrated in FIGS. 11 and 12, the electrically powered vehicle 150 is a structure similar to the electrically powered vehicle 140 described above with reference to FIGS. 9 and 10, to which the connecting members 77, 78, and 79 of the electrically powered vehicle 120 described above with reference to FIGS. 6 and 7 are added.

The electrically powered vehicle 150 may further reduce the amount of entry of the pole upon a side collision as impact energy can be absorbed through, in addition to deformation of the first, second, and third cross members 14, 15, and 16 and collapse of the right impact absorbing member 61R, collapse of the fragile portions of the connecting members 77, 78, and 79.

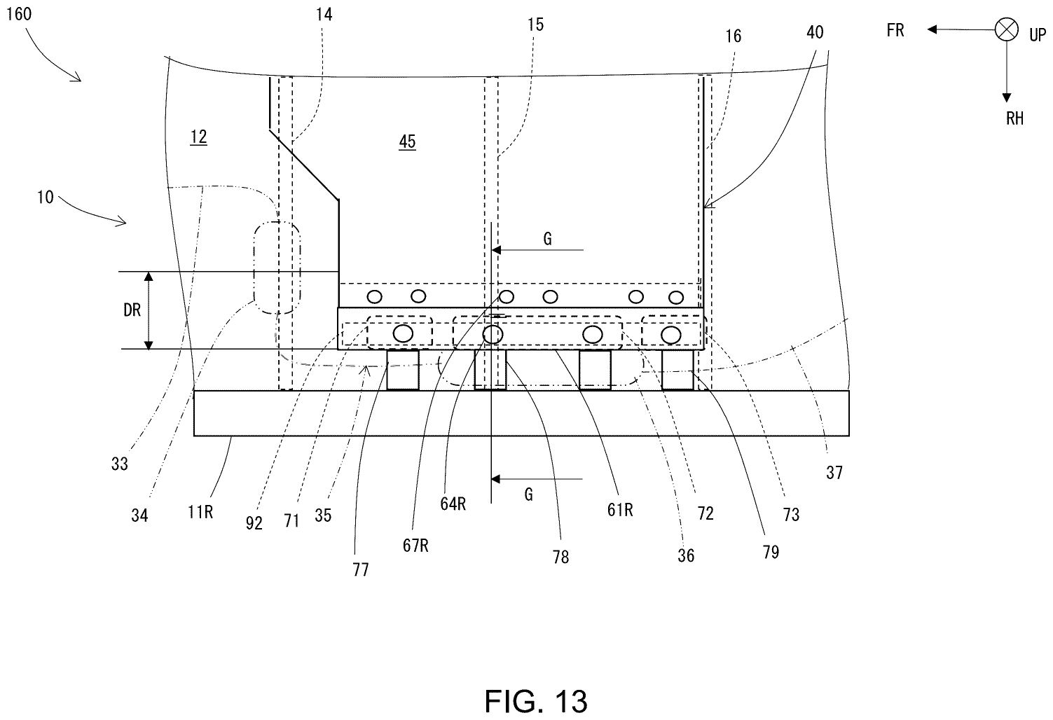

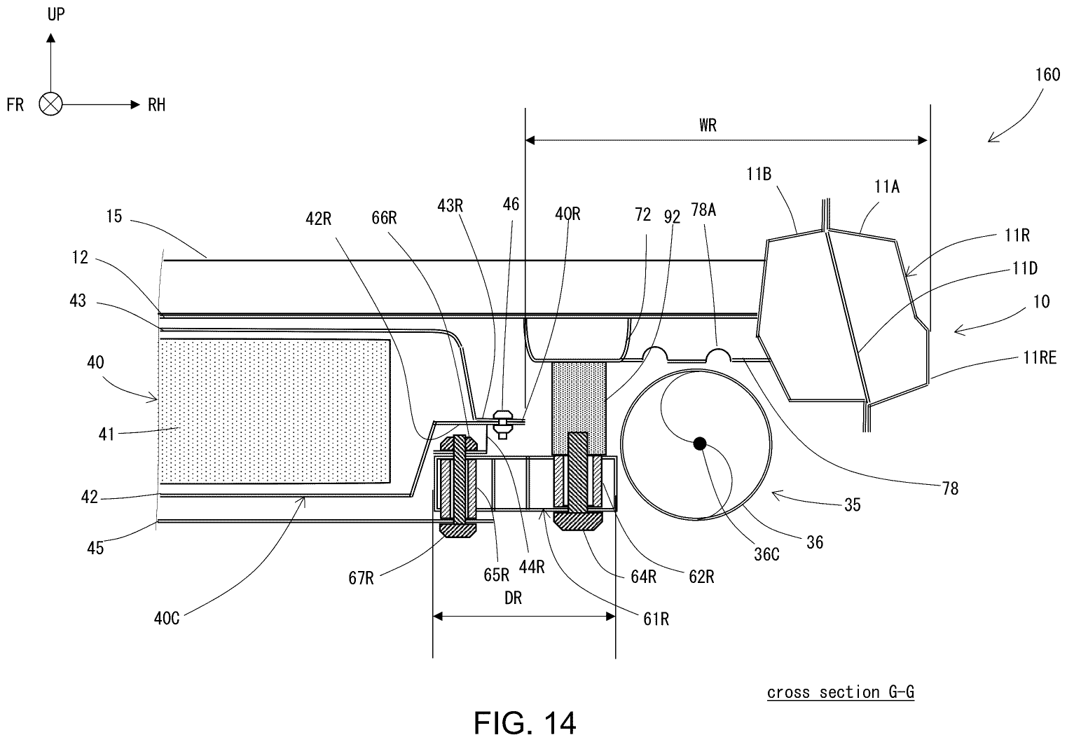

Referring next to FIGS. 13 and 14, an electrically powered vehicle 160 according to another embodiment will be described below. The same portions as those of the electrically powered vehicle 150 described above with reference to FIGS. 11 and 12 are denoted by the same reference numerals, and their description is not repeated here. As illustrated in FIGS. 13 and 14, the electrically powered vehicle 160 has a structure in which the bases 71, 72, and 73 have, on their lower surfaces, a wall member 92 extending in the vehicle longitudinal direction.

As illustrated in FIGS. 13 and 14, the wall member 92 is a thick flat member extending in the vehicle longitudinal direction. The upper end of the wall member 92 is connected to the bases 71, 72, and 73. The lower end of the wall member 92 extends more toward the lower side of the vehicle than the center 36C of the second large diameter section 36 of the exhaust pipe 35. The wall member 92 has, on its lower surface, the right impact absorbing member 61R that is connected with the bolts 64R. A right end of the driving battery 40 is supported by the right impact absorbing member 61R, the bolts 64R, the wall member 92, and the bases 71, 72, and 73.

The electrically powered vehicle 160 can absorb impact energy upon a side collision as the second large diameter section 36 of the exhaust pipe 35 is collapsed by the wall member 92. Therefore, an increase in amount of absorption of impact energy upon a side collision compared to the electrically powered vehicle 150 may further reduce the distance of entry of the pole.

1. An electrically powered vehicle comprising:
an internal combustion engine;
a driving battery disposed under a floor of a body;
a pipe connected to the internal combustion engine and extending in a vehicle longitudinal direction to be disposed toward a first-side outer side of the driving battery in a vehicle width direction; and
a second-side impact absorbing member disposed toward a second-side outer side of the driving battery in the vehicle width direction.

2. The electrically powered vehicle according to claim 1, further comprising:
a first-side impact absorbing member disposed toward the first-side outer side of the driving battery in the vehicle width direction,
wherein the first-side impact absorbing member has a length in the vehicle width direction, the length being shorter than that of the second-side impact absorbing member.

3. The electrically powered vehicle according to claim 1,
wherein the pipe extends in the vehicle longitudinal direction in a first-side vehicle side portion of the body, and
wherein the driving battery is disposed toward a second side of the body with a length between a second-side outer end of the driving battery in the vehicle width direction and a second-side outer end of the body in the vehicle width direction being shorter than a length between a first-side outer end of the driving battery in the vehicle width direction and a first-side outer end of the body in the vehicle width direction.

4. The electrically powered vehicle according to claim 2,
wherein the pipe extends in the vehicle longitudinal direction in a first-side vehicle side portion of the body, and
wherein the driving battery is disposed toward a second side of the body with a length between a second-side outer end of the driving battery in the vehicle width direction and a second-side outer end of the body in the vehicle width direction being shorter than a length between a first-side outer end of the driving battery in the vehicle width direction and a first-side outer end of the body in the vehicle width direction.

5. The electrically powered vehicle according to claim 3,
wherein the body includes a first-side rocker disposed in the first-side vehicle side portion of the body and extending in the vehicle longitudinal direction and a second-side rocker disposed in a second-side vehicle side portion of the body and extending in the vehicle longitudinal direction,
wherein the second-side impact absorbing member connects between a lower portion of the second-side rocker and the second-side outer end of the driving battery in the vehicle width direction, and
wherein the second-side outer end of the driving battery in the vehicle width direction extends in the vehicle width direction to reach a vicinity of the second-side rocker.

6. The electrically powered vehicle according to claim 4,
wherein the body includes a first-side rocker disposed in the first-side vehicle side portion of the body and extending in the vehicle longitudinal direction and a second-side rocker disposed in a second-side vehicle side portion of the body and extending in the vehicle longitudinal direction,
wherein the second-side impact absorbing member connects between a lower portion of the second-side rocker and the second-side outer end of the driving battery in the vehicle width direction, and
wherein the second-side outer end of the driving battery in the vehicle width direction extends in the vehicle width direction to reach a vicinity of the second-side rocker.

7. The electrically powered vehicle according to claim 5,
wherein the body includes a floor panel laid out between the first-side rocker and the second-side rocker, a cross member connected to an upper surface of the floor panel and connecting the first-side rocker and the second-side rocker in the vehicle width direction, and at least one base connected to a lower surface of a first-side vehicle side portion of the floor panel,
wherein the at least one base is disposed adjacent to the pipe toward an inner side of the pipe in the vehicle width direction and connected to the cross member with the floor panel interposed therebetween, and
wherein the first-side outer end of the driving battery in the vehicle width direction extends in the vehicle width direction to reach a vicinity of the pipe and is connected to the at least one base.

8. The electrically powered vehicle according to claim 6,
wherein the body includes a floor panel laid out between the first-side rocker and the second-side rocker, a cross member connected to an upper surface of the floor panel and connecting the first-side rocker and the second-side rocker in the vehicle width direction, and at least one base connected to a lower surface of a first-side vehicle side portion of the floor panel,
wherein the at least one base is disposed adjacent to the pipe toward an inner side of the pipe in the vehicle width direction and connected to the cross member with the floor panel interposed therebetween, and
wherein the first-side outer end of the driving battery in the vehicle width direction extends in the vehicle width direction to reach a vicinity of the pipe and is connected to the at least one base.

9. The electrically powered vehicle according to claim 7,
wherein the at least one base is disposed adjacent to the pipe and, as viewed from below the vehicle, a portion of the at least one base overlaps the pipe in the vehicle width direction.

10. The electrically powered vehicle according to claim 8,
wherein the at least one base is disposed adjacent to the pipe and, as viewed from below the vehicle, a portion of the at least one base overlaps the pipe in the vehicle width direction.

11. The electrically powered vehicle according to claim 7,
wherein the at least one base extends toward the first-side rocker in the vehicle width direction and is connected to the first-side rocker, and
wherein the at least one base includes at least one fragile portion.

12. The electrically powered vehicle according to claim 7, further comprising:
a connecting member that connects between the at least one base and the first-side rocker in the vehicle width direction,
wherein the connecting member includes at least one fragile portion.

13. The electrically powered vehicle according to claim 3,
wherein a first-side outer surface of the driving battery in the vehicle width direction is a vertical wall that opposes the pipe, and
wherein the vertical wall has a lower end that is located more toward a lower side of the vehicle than a center of the pipe.

14. The electrically powered vehicle according to claim 2,
wherein the pipe extends in the vehicle longitudinal direction in a first-side vehicle side portion of the body,
wherein the second-side impact absorbing member is disposed between a second-side outer end of the driving battery in the vehicle width direction and a second-side outer end of the body in the vehicle width direction, and
wherein the first-side impact absorbing member is disposed between a first-side outer end of the driving battery in the vehicle width direction and the pipe.

15. The electrically powered vehicle according to claim 14,
wherein the body includes a first-side rocker disposed in the first-side vehicle side portion of the body and extending in the vehicle longitudinal direction, a second-side rocker disposed in a second-side vehicle side portion of the body and extending in the vehicle longitudinal direction, a floor panel laid out between the first-side rocker and the second-side rocker, a cross member connected to an upper surface of the floor panel and connecting the first-side rocker and the second-side rocker in the vehicle width direction, and at least one base connected to a lower surface of a first-side vehicle side portion of the floor panel and connected to the cross member with the floor panel interposed therebetween,
wherein the at least one base is disposed adjacent to the pipe toward an inner side of the pipe in the vehicle width direction and connected to the cross member with the floor panel interposed therebetween, and
wherein the first-side impact absorbing member connects between a lower portion of the at least one base and the first-side outer end of the driving battery in the vehicle width direction,
wherein the first-side outer end of the driving battery in the vehicle width direction extends in the vehicle width direction to reach a vicinity of the pipe and is connected to the at least one base,
wherein the second-side impact absorbing member connects between a lower portion of the second-side rocker and the second-side outer end of the driving battery in the vehicle width direction, and
wherein the second-side outer end of the driving battery in the vehicle width direction extends in the vehicle width direction to reach a vicinity of the second-side rocker.

16. The electrically powered vehicle according to claim 15,
wherein the at least one base is disposed adjacent to the pipe and, as viewed from below the vehicle, a portion of the at least one base overlaps the pipe in the vehicle width direction.

17. The electrically powered vehicle according to claim 15,
wherein the at least one base extends toward the first-side rocker in the vehicle width direction and is connected to the first-side rocker, and
wherein the at least one base includes at least one fragile portion.

18. The electrically powered vehicle according to claim 15, further comprising:
a connecting member that connects between the at least one base and the first-side rocker in the vehicle width direction,
wherein the connecting member includes at least one fragile portion.

19. The electrically powered vehicle according to claim 15, further comprising:
a wall member connected to the at least one base and extending in the vehicle longitudinal direction,
wherein the first-side impact absorbing member connects between the wall member and the first-side outer end of the driving battery in the vehicle width direction.

20. The electrically powered vehicle according to claim 19,
wherein the wall member has a lower end that is located more toward a lower side of the vehicle than a center of the pipe.
